(19) United States
(12) Patent Application Publication
(10) Pub. No.: US 2026/0078052 A1
(43) Pub. Date: Mar. 19, 2026

(54) CHEMICALLY STRENGTHENED GLASS AND METHOD FOR PRODUCING CHEMICALLY STRENGTHENED GLASS

(71) Applicant: AGC Inc., Tokyo (JP)

(72) Inventor: Kaname SEKIYA, Tokyo (JP)

(73) Assignee: AGC Inc., Tokyo (JP)

(21) Appl. No.: 19/326,453

(22) Filed: Sep. 11, 2025

(30) Foreign Application Priority Data
Sep. 19, 2024 (JP) 2024-161665

(51) Int. Cl. C03C 21/00; C03C 10/00

(52) U.S. Cl. CPC C03C 21/002; C03C 10/00; C03C 10/0027

(57) ABSTRACT

Provided is a novel type of chemically strengthened glass that has not existed before. The chemically strengthened glass of the present invention has a maximum measured voltage with an absolute value of 800 V or less as measured by a static honestmeter in a charging test in which the chemically strengthened glass is charged for 30 seconds by generating a corona discharge at an applied voltage of 10 kV.

### TECHNICAL FIELD

The present invention relates to chemically strengthened glass.

The present invention also relates to a method for producing chemically strengthened glass.

### BACKGROUND ART

In recent years, cover glasses have been used for the purpose of protection and appearance improvement of display devices of mobile phones, smartphones, tablet terminals and the like. The cover glasses for these applications are required to have high strength to prevent breakage by impact etc.

Such cover glasses may also be used for protection of solar cell modules and the like.

Conventionally known is a technique for improving the surface strength of glass by chemically strengthening the glass through immersion in a molten salt of potassium nitrate etc.

For example, Patent Document 1 discloses that the surface strength of sheet glass is improved by chemically strengthening the glass through immersion in a molten salt of potassium nitrate. More specifically, this patent document discloses production of sheet glass with improved strength by chemical strengthening treatment of Li-containing glass with a Na-containing molten salt and then with a K-containing molten salt. Further, this patent document describes that the mechanism for strengthening sheet glass through the above chemical treatment is due to compressive stress caused by exchange of alkali metals.

### PRIOR ART DOCUMENTS

### Patent Documents

Patent Document 1: WO 2017/170053

### DISCLOSURE OF INVENTION

### Technical Problem

With the recent diversification of devices, there has been a demand for novel types of glass with various characteristics.

The present invention has been made in view of the above problem. It is an object of the present invention to provide a novel type of chemically strengthened glass that has not existed before.

It is also an object of the present invention to provide a method for producing chemically strengthened glass.

### Solution to Problem

As a result of intensive studies made on the above-mentioned problem, the present inventor has found chemically strengthened glass whose voltage measured by a static honestmeter takes a predetermined value or smaller, and thus accomplished the present invention.

In other words, the present inventor has found the following solutions to the above-mentioned problem.
[1] Chemically strengthened glass having a maximum measured voltage with an absolute value of 800 V or less as measured by a static honestmeter in a charge test in which the chemically strengthened glass is charged for 30 seconds by generating a corona discharge at an applied voltage of 10 kV.
[2] The chemically strengthened glass according to [1], wherein the ratio of a voltage of the chemically strengthened glass as measured at a lapse of 2 seconds from the stop of the corona discharge after the charge test, to the maximum measured voltage, is 0.200 or lower.
[3] The chemically strengthened glass according to [1] or [2], wherein a Young's modulus of the chemically strengthened glass is 90 GPa or higher.
[4] The chemically strengthened glass according to any one of [1] to [3], wherein a depth in μm of compressive stress layer DOC of the chemically strengthened glass is greater than or equal to 0.16 times a sheet thickness in μm of the chemically strengthened glass.
[5] The chemically strengthened glass according to any one of [1] to [4], wherein an average value CTₐᵥₑ of tensile stress in the chemically strengthened glass is 80 MPa or lower.
[6] The chemically strengthened glass according to any one of [1] to [5], wherein a potassium ion exchange depth of the chemically strengthened glass is 1.8 μm or greater.
[7] The chemically strengthened glass according to any one of [1] to [6], wherein a sheet thickness of the chemically strengthened glass is 1.0 mm or smaller.
[8] The chemically strengthened glass according to any one of [1] to [7], wherein the chemically strengthened glass is in the form of crystallized glass.
[9] The chemically strengthened glass according to [8], wherein the crystallized glass comprises at least one type selected from the group consisting of lithium silicate crystal and lithium aluminosilicate crystal.
[10] The chemically strengthened glass according to [8] or [9], wherein the crystallized glass comprises at least one type selected from the group consisting of lithium disilicate crystal, β-spodumene crystal, β-quartz solid solution crystal and petalite crystal.
[11] A method for producing chemically strengthened glass, comprising performing chemical strengthening treatment on glass for chemical strengthening by contact with a molten salt to obtain chemically strengthened glass,
   wherein the content of KNO₃ in the molten salt is 60 mass % or more to the total mass of the molten salt, and the content of NaNO₃ in the molten salt is 20 mass % or more to the total mass of the molten salt, and
   wherein a treatment temperature of the chemical strengthening treatment is 450° C. or higher, and a treatment time of the chemical strengthening treatment is 6 hours or more.
[12] The method for producing chemically strengthened glass according to [11], wherein the treatment temperature of the chemical strengthening treatment is from 450 to 480° C.
[13] The method for producing chemically strengthened glass according to [11] or [12], wherein the treatment time of the chemical strengthening treatment is from 6 to 24 hours.
[14] The method for producing chemically strengthened glass according to any one of [11] to [13], wherein the glass for chemical strengthening is in the form of crystallized glass.
[15] The method for producing chemically strengthened glass according to [14], wherein the crystallized glass comprises at least one type selected from the group consisting of lithium silicate crystal and lithium aluminosilicate crystal.
[16] The method for producing chemically strengthened glass according to [14] or [15], wherein the crystallized glass comprises at least one type selected from the group consisting of lithium disilicate crystal, β-spodumene crystal, β-quartz solid solution crystal and petalite crystal.

### Advantageous Effects of Invention

The present invention provides a novel type of chemically strengthened glass.

The present invention also provides a method for producing chemically strengthened glass.

### BRIEF DESCRIPTION OF DRAWINGS

FIG. 1 is a schematic view illustrating a sample for measurement of fracture toughness value K_{IC} by the double cleavage drilled compression (DCDC) method.

FIG. 2 is a diagram illustrating a K1-v curve, which indicates a relationship between stress intensity factor K1 (unit: MPa·m^{1/2}) and crack propagation rate v (unit: m/s), as used for measurement of fracture toughness value K_{IC} by the DCDC method.

### DESCRIPTION OF EMBODIMENTS

Hereinafter, the chemically strengthened glass of the present invention will be described in detail below. It should be understood that: the present invention is not limited to the following embodiments; and various changes and modifications of the following embodiments are possible within the range that does not depart from the scope of the present invention.

In the present specification, “chemically strengthened glass” refers to glass having been subjected to chemical strengthening treatment; and “glass for chemical strengthening” refers to glass before being subjected to chemical strengthening treatment.

In the present specification, a glass composition of glass for chemical strengthening may also be referred to as a base glass composition of chemically strengthened glass. Since chemically strengthened glass usually has a compressive stress layer formed in a surface portion thereof by ion exchange, the glass composition of a non-ion-exchanged portion of the chemically strengthened glass corresponds to the base glass composition of the chemically strengthened glass.

In the present specification, a glass composition is expressed in mole percentage on the oxide basis; and mol % may be simply referred to as %. Further, a numerical range expressed using “to” means a range including numerical values described before and after “to” as lower and upper limits.

In a glass composition, “substantially free of” means that it is not contained except as an unavoidable impurity in raw material etc., that is, it is not intentionally contained. More specifically, the content of a component other than those described as the glass composition is, for example, preferably less than 0.1 mol %, more preferably 0.08 mol % or less, still more preferably 0.05 mol % or less.

In the present specification, a “stress profile” refers to a pattern representing a value of compressive stress with a depth from glass surface taken as a variable. A negative compressive stress value means tensile stress.

In the present specification, a “stress profile” can be measured by a method using a scattered light photoelastic stress meter.

By the method using the scattered light photoelastic stress meter, stress measurement can be carried out irrespective of the refractive index distribution from the surface to the inside of chemically strengthened glass. As an example of the scattered light photoelastic stress meter, SLP 2000 manufactured by Orihara Industrial Co., Ltd. may be mentioned.

In the present specification, a “depth of compressive stress layer” refers to a depth at which the compressive stress value becomes zero.

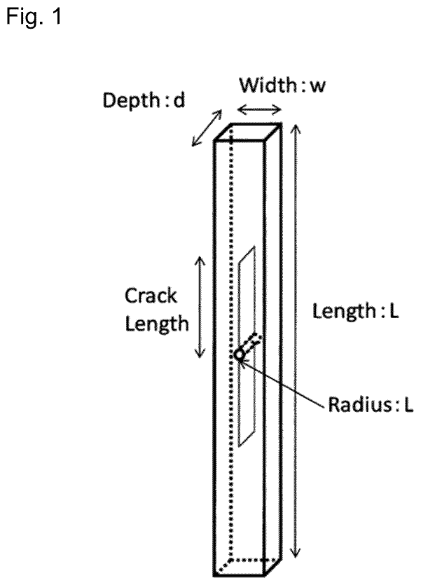

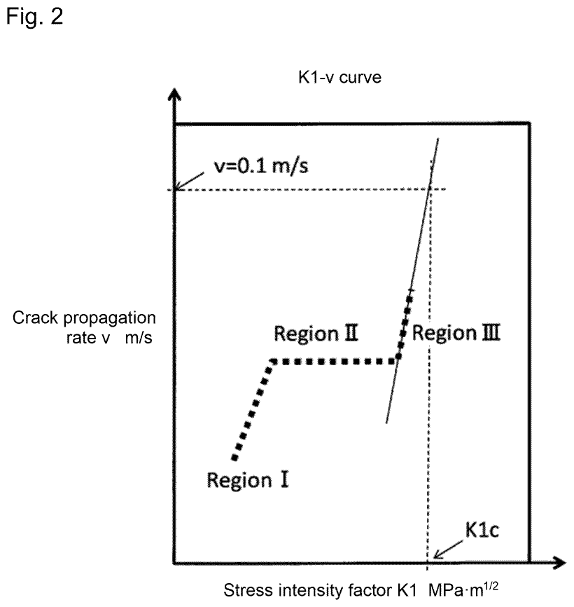

In the present specification, a “fracture toughness value K_{IC}” refers to a value measured with reference to the DCDC method (see, for reference, M. Y. He, M. R. Turner and A. G. Evans, Acta Metall. Mater., 43 (1995), 3453). More specifically, using a sample having a shape shown in FIG. 1 and a SHIMADZU autograph AGS-X5KN, measured is a K1-v curve that indicates a relationship between stress intensity factor K1 (unit: MPa·m^{1/2}) and crack propagation rate v (unit: m/s) as shown in FIG. 2. The obtained Region III data is regressed to a linear expression, and by extrapolation of the linear expression, the stress intensity factor K1 corresponding to v=0.1 m/s is taken as the fracture toughness value K_{IC}.

### <Chemically Strengthened Glass>

The chemically strengthened glass of the present invention has a maximum measured voltage with an absolute value of 800 V or less as measured by a static honestmeter in a charge test in which the chemically strengthened glass is charged for 30 seconds by generating a corona discharge at an applied voltage of 10 kV.

Here, the method for implementation of the charge test and the method for measurement of the maximum measured voltage will be described below.

### [Maximum Measured Voltage]

In the present invention, a Static Honestmeter (H0110-S4) manufactured by Shishido Electrostatic, Ltd. is usable as the static honestmeter.

The measurement environment is set to a temperature of 22 to 25° C. and a relative humidity of 47 to 55%.

The static honestmeter includes: a turntable that holds a measurement sample; an application unit connected to a high-voltage direct-current power supply for corona discharge generation; and a power reception unit that measures a voltage across the measurement sample.

The turntable has a sample holding frame for holding the measurement sample such that a part of the measurement sample is exposed at a surface of the sample holding frame.

The measurement sample is prepared by cutting chemically strengthened glass into a size of 45 mm (length)×45 mm (width).

The measurement sample is fixed to the sample holding frame of the turntable. After the fixing, the height of the application unit is adjusted such that the distance from the frame surface of the sample holding frame to a tip end of a needle electrode of the application unit is set to 18 mm. Further, the height of the power reception unit is adjusted such that the distance from the frame surface of the sample holding frame to an electrode of the power reception unit is set to 13 mm.

Subsequently, electrostatic charges on the measurement sample are eliminated by a charge eliminator.

The measurement sample is then charged by generating a corona discharge at an applied voltage of 10 kV while rotating the turntable. The charge time is set to 30 seconds.

The maximum value of voltage measured by the power reception unit during the charging is recorded as the maximum measured voltage (unit: V). Here, the maximum value of voltage refers to a value at which the absolute value of the voltage becomes maximum.

The above voltage measurement is conducted on five measurement samples, and the arithmetic mean of the obtained maximum measured voltages of these measurement samples is taken as the maximum measured voltage of the chemically strengthened glass.

The absolute value of the maximum measured voltage of the chemically strengthened glass of the present invention is 800 V or less, preferably 700 V or less, and may be 500 V or less, 300 V or less, 100 V or less, or 50 V or less.

The absolute value of the maximum measured voltage is usually 5 V or more.

The absolute value of the maximum measured voltage can be adjusted according to the composition and chemical strengthening treatment conditions of glass for chemical strengthening used for production of the chemically strengthened glass. The details will be described later.

The chemically strengthened glass of the present invention is considered to have a surface less likely to be charged because of the small value of the maximum measured voltage.

Since the surface of the chemically strengthened glass of the present invention is less likely to be charged, a member using the chemically strengthened glass of the present invention is considered to be excellent in electrostatic discharge resistance (ESD resistance). A member using the chemically strengthened glass of the present invention is also considered to have a surface less prone to adhesion of particles such as dust.

### [Charge Characteristics]

It is preferable that the chemically strengthened glass of the present invention has a ratio of V_{2S} to V_{MAX} (hereinafter also referred to as “V_{2S}/V_{MAX} ratio”) of 0.200 or lower where V_{MAX} is the above-described maximum measured voltage; and V_{2S} is the voltage of the chemically strengthened glass as measured at a lapse of 2 seconds from the stop of the corona discharge after the charge test.

The V_{2S}/V_{MAX} ratio is more preferably 0.100 or lower, still more preferably 0.070 or lower, and may be 0.040 or lower, 0.010 or lower, or 0.005 or lower. The V_{2S}/V_{MAX} ratio may be 0.000, and is usually 0.001 or higher.

The voltage of the chemically strengthened glass at the lapse of 2 seconds from the stop of the corona discharge is measured with the use of the above-described static honestmeter by just stopping the corona discharge after the measurement of the maximum measured voltage in the charge test and then taking a reading of the static honestmeter at the lapse of 2 seconds from the stop of the corona discharge. The measured voltage is in V.

The above voltage measurement is conducted on five measurement samples, and the arithmetic mean of the measured voltage values is taken as the voltage (V_{2S}) measured at the lapse of 2 seconds from the stop of the corona discharge.

The voltage V_{2S} is preferably 150 V or lower, more preferably 100 V or lower, still more preferably 50 V or lower, and may be 10 V or lower, 1 V or lower, or 0.1 V or lower. The voltage V_{2S} may be 0.000 V, and is usually 0.001 V or higher.

The voltage V_{2S} can be adjusted according to the composition and chemical strengthening treatment conditions of glass for chemical strengthening used for production of the chemically strengthened glass. The details will be described later.

### [Compressive Stress]

The chemically strengthened glass of the present invention usually has a compressive stress layer in which compressive stress acts on the surface side. In the following, preferable parameters related to compressive stress will be described.

The compressive stress (CS₅₀) at a depth of 50 μm in the chemically strengthened glass of the present invention is preferably 30 MPa or higher, more preferably 40 MPa or higher, still more preferably 50 MPa or higher, from the viewpoint of less breakage of the glass even by a larger impact upon collision with another object. Further, the compressive stress CS₅₀ in the chemically strengthened glass of the present invention is usually 300 MPa or lower, preferably 200 MPa or lower, more preferably 150 MPa or lower, so as to not exceed the CT limit of the glass.

The compressive stress (CS₁₀₀) at a depth of 100 μm in the chemically strengthened glass of the present invention is preferably −10 MPa or higher, more preferably 0 MPa or higher, still more preferably 5 MPa or higher, from the viewpoint of less breakage of the glass even by a larger impact upon collision with another object. Further, the compressive stress CS₁₀₀ in the chemically strengthened glass of the present invention is usually 150 MPa or lower, preferably 100 MPa or lower, more preferably 50 MPa or lower, still more preferably 20 MPa or lower, particularly preferably 15 MPa or lower, so as to not exceed the CT limit of the glass.

The compressive stress at each depth can be determined from a stress profile obtained by the above-described method.

The depth of compressive stress layer DOC of the chemically strengthened glass of the present invention is preferably 60 μm or greater, more preferably 80 μm or greater, still more preferably 100 μm or greater. The depth of compressive stress layer DOC of the chemically strengthened glass of the present invention is preferably 180 μm or smaller, more preferably 160 μm or smaller, still more preferably 140 μm or smaller.

Furthermore, the depth of compressive stress layer DOC of the chemically strengthened glass of the present invention is preferably greater than or equal to 0.16 times, more preferably greater than or equal to 0.17 times, the sheet thickness of the chemically strengthened glass of the present invention. Here, both of the depth of compressive stress layer DOC and the sheet thickness are in μm. In other words, the value obtained by dividing the depth (unit: μm) of compressive stress layer DOC by the sheet thickness (unit: μm) is preferably 0.16 or greater, more preferably 0.17 or greater.

The depth of compressive stress layer DOC of the chemically strengthened glass is usually smaller than or equal to 0.25 times the sheet thickness of the chemically strengthened glass.

### [Tensile Stress]

The chemically strengthened glass of the present invention usually has a compressive stress layer on its surface. In this case, tensile stress acts inside the chemically strengthened glass so as to balance the compressive stress.

In the following, preferable parameters related to tensile stress will be described.

The maximum value (CT_{Max}) of tensile stress in the chemically strengthened glass of the present invention is preferably 20 MPa or higher, more preferably 30 MPa or higher, still more preferably 40 MPa or higher, particularly preferably 50 MPa or higher. Further, the maximum value CT_{Max} of tensile strength in the chemically strengthened glass of the present invention is usually 200 MPa or lower, preferably 150 MPa or lower, more preferably 100 MPa or lower, still more preferably 70 MPa or lower.

The maximum tensile stress CT_{Max} is determined from a stress profile and, in general, acts at a sheet thickness center position.

The average value (CTₐᵥₑ) of tensile stress in the chemically strengthened glass of the present invention is preferably 10 MPa or higher, more preferably 20 MPa or higher, still more preferably 30 MPa or higher. Further, the average value CTₐᵥₑ of tensile stress in the chemically strengthened glass of the present invention is usually 140 MPa or lower, preferably 100 MPa or lower, more preferably 60 MPa or lower.

The average tensile stress value CTₐᵥₑ is determined by obtaining a stress profile and, in a depth region of the stress profile corresponding to tensile stress, dividing an integral value of the tensile stress in a thickness direction of the glass by a length of the tensile stress region.

The integral value (ICT) of tensile stress in the chemically strengthened glass of the present invention is usually 40000 Pa·m or lower, preferably 30000 Pa·m or lower, more preferably 20000 Pa·m or lower. The lower limit of the integral tensile stress value ICT is not particularly limited, and is usually 8000 Pa·m or higher, preferably 10000 Pa·m or higher.

The integral tensile stress value ICT is determined by obtaining a stress profile and integrating the tensile stress value in a depth region of the stress profile corresponding to tensile stress.

### [Sheet Thickness]

The sheet thickness of the chemically strengthened glass of the present invention can be adjusted as appropriate depending on the intended use, and is usually 0.1 mm or greater, preferably 0.2 mm or greater, more preferably 0.3 mm or greater, still more preferably 0.4 mm or greater. Further, the sheet thickness of the chemically strengthened glass of the present invention is usually 2.0 mm or smaller, preferably 1.5 mm or smaller, more preferably 1.2 mm or smaller, still more preferably 1.0 mm or smaller, particularly preferably 0.8 mm or smaller, and may be 0.7 mm or smaller.

### [Physical Properties]

The Young's modulus of the chemically strengthened glass of the present invention is preferably 80 GPa or higher, more preferably 85 GPa or higher, still more preferably 90 GPa or higher, particularly preferably 95 GPa or higher, most preferably 100 GPa or higher. The upper limit of the Young's modulus is not particularly limited, and is typically 120 GPa or lower.

The Young's modulus of the chemically strengthen glass is generally the same as the Young's modulus of glass for chemical strengthening.

The fracture toughness value K_{IC} of the chemically strengthened glass of the present invention is preferably 0.80 MPa·m^{1/2} or higher, more preferably 0.85 MPa·m^{1/2} or higher, still more preferably 0.90 MPa·m^{1/2} or higher, particularly preferably 1.00 MPa·m^{1/2} or higher, most preferably 1.10 MPa·m^{1/2} or higher. The upper limit of the fracture toughness value K_{IC} is not particularly limited, and is typically 2.00 MPa·m^{1/2} or lower.

The fracture toughness value K_{IC} of the chemically strengthened glass is generally the same as the fracture toughness value K_{IC} of glass for chemical strengthening.

### [Elemental Distribution]

It is preferable that the chemically strengthened glass of the present invention contains K in the vicinity of its surface.

The presence or absence of K in the vicinity of the surface of the chemically strengthened glass of the present invention can be confirmed by glow discharge optical emission spectrometry (GD-OES).

In the GD-OES, gas (typically, Ar gas) is ionized by generation of a glow discharge in a hollow electrode; and, with the application of a high-frequency voltage to a sample, the ionized gas is brought into collision with a surface of the sample so that the surface of the sample is sputtered with the ionized gas. The elements constituting the sputtered sample are fed into a plasma formed by the glow discharge, and then, excited or relaxed to emit light at wavelengths characteristic to the constituting elements. By analyzing this light, the contents of the respective elements in the sample are determined.

Since the analysis is performed while sputtering the surface of the sample, the analysis in the depth direction is possible.

The detailed analysis method is as described later in Examples.

By the above method, the distribution of K in the depth direction can be measured.

When the chemically strengthened glass of the present invention contains K in the vicinity of its surface, K is preferably the one introduced by chemical strengthening treatment. In other words, K detected by the above method is preferably the one introduced by chemical strengthening treatment.

More specifically, the depth of introduction of K by ion exchange (hereinafter also referred to as the “K ion exchange depth”) is preferably 1.5 μm or greater, more preferably 1.8 μm or greater, still more preferably 2.0 μm or greater, and may be 2.5 μm or greater. The K ion exchange depth is preferably 10.0 μm or smaller, more preferably 8.0 μm or smaller, still more preferably 4.0 μm or smaller, most preferably 3.0 μm or smaller.

Here, the K ion exchange depth refers to a depth determined by measuring the distribution of K in the depth direction according to the above method and analyzing the measured distribution according to the method described later in Examples.

### [Composition]

The chemically strengthened glass of the present invention is obtained by performing chemical strengthening treatment on glass to be chemically strengthened (glass for chemical strengthening).

The composition of the glass for chemical strengthening is usually the same as the composition of the chemically strengthened glass at the sheet thickness center position. In other words, the preferable composition of the chemically strengthened glass at the sheet thickness center position is usually the same as the preferable composition of the glass for chemical strengthening.

The glass for chemical strengthening preferably has a composition including, in mole percentage on an oxide basis,
60 to 75% of SiO₂,
1 to 5% of Al₂O₃,
0 to 5% of P₂O₅,
6 to 30% of Li₂O,
0 to 5% of Na₂O,
0 to 2% of K₂O,
0 to 10% of MgO,
0 to 5% of CaO, and
1 to 10% of ZrO₂.

The more preferable composition of the glass for chemical strengthening and the method for producing the glass for chemical strengthening will be described later.

Furthermore, it is preferable that the glass for chemical strengthening is in the form of crystallized glass. When the glass for chemical strengthening is crystallized glass and is chemically strengthened, the chemically strengthened glass is obtained in the form of crystallized glass. In other words, it is preferable that the chemically strengthened glass of the present invention is in the form of crystallized glass.

Crystals contained in the glass for chemical strengthening are also contained in the chemically strengthened glass, and thus, preferred examples of crystals in the chemically strengthened glass are the same as preferred examples of crystals in the glass for chemical strengthening. Since the preferred embodiments of the chemically strengthened glass in the form of crystallized glass are the same as those of the glass for chemically strengthening in the form of crystallized glass, a duplicated description thereof will be omitted.

### <Method for Producing Chemically Strengthened Glass>

The method for producing the chemically strengthened glass of the present invention includes performing chemical strengthening treatment on glass for chemical strengthening by contact with a molten salt to obtain chemically strengthened glass.

Here, the content of KNO₃ in the molten salt is 60 mass % or more to the total mass of the molten salt, and the content of NaNO₃ in the molten salt is 20 mass % or more to the total mass of the molten salt.

Further, the treatment temperature of the chemical strengthening treatment is 450° C. or higher, and the treatment time of the chemical strengthening treatment is 6 hours or more.

The method for producing the chemically strengthened glass of the present invention will be described in detail below.

### [Glass for Chemical Strengthening]

### (Composition)

The composition of the glass for chemical strengthening as a material for production of the chemically strengthened glass of the present invention will first be described below. Hereinafter, the preferable composition of the glass for chemical strengthening is also referred to as a “base glass composition”.

The preferable composition (base glass composition) of the glass for chemical strengthening as used in the present invention includes, in mole percentage on the oxide basis,
60 to 75% of SiO₂,
1 to 5% of Al₂O₃,
0 to 5% of P₂O₅,
6 to 30% of Li₂O,
0 to 5% of Na₂O,
0 to 2% of K₂O,
0 to 10% of MgO,
0 to 5% of CaO, and
1 to 10% of ZrO₂.

In the following, the respective components of the base glass composition will be described.

SiO₂ is a component for forming a network structure in glass. SiO₂ is also a component for improving the chemical resistance of glass and a component for suppressing the occurrence of cracks in glass due to scratches caused on a surface of the glass.

With a view to improvement of chemical resistance, the content of SiO₂ is more preferably 63.0% or more, still more preferably 65.0% or more. On the other hand, the content of SiO₂ is more preferably 74.0% or less, still more preferably 72.0% or less, from the viewpoint of obtaining good meltability.

Al₂O₃ is a component for improving the ion exchange performance of glass during chemical strengthening to increase surface compressive stress in the glass after the chemical strengthening. Further, Al₂O₃ contributes to the formation of crystals containing Al and Li.

From the viewpoint of obtaining the above effects, the content of Al₂O₃ is more preferably 3.5% or more, still more preferably 4.0% or more. On the other hand, it may be required that: crystals are difficult to grow during melting of the glass; devitrification defects are less likely to occur in the glass, thereby easily achieving a higher yield; or the glass is made lower in high-temperature viscosity and easier to melt. From such viewpoints, the content of Al₂O₃ is more preferably 4.8% or less, still more preferably 4.6% or less.

Each of SiO₂ and Al₂O₃ acts to stabilize the structure of glass. The total content of SiO₂ and Al₂O₃ is preferably 64.0% or more, more preferably 66.0% or more, still more preferably 68.0% or more, with a view to reduction of brittleness.

Further, each of SiO₂ and Al₂O₃ tends to raise the melting temperature of glass. From the viewpoint of ease of glass melting, the total content of SiO₂ and Al₂O₃ is preferably 80.0% or less, more preferably 78.0% or less, still more preferably 76.0% or less, particularly preferably 74.0% or less.

Li₂O is a component capable of ion exchange reaction and is a component for improving the meltability of glass. When Li₂O is contained in glass, a stress profile with high surface compressive stress and thick compressive stress layer is easily obtained by exchanging Li ions on the glass surface with external Na ions to introduce Na ions to the inside of the glass and then exchanging the introduced Na ions with external K ions. Further, crystallized glass is easily obtained by specific heat treatment when the content of Li₂O is in the above range. From such viewpoints, the content of Li₂O is more preferably 15% or more, still more preferably in the following order: 18% or more, and 20% or more, and may be 25% or more.

On the other hand, the content of Li₂O is more preferably 29% or less, from the viewpoint of lowering the rate of crystal growth during glass forming and suppressing a deterioration of quality due to devitrification.

Na₂O and K₂O are components for improving the meltability of glass and lowering the rate of crystal growth during glass forming. With a view to not only obtaining these effects but also improving the ion exchange performance of the glass, it is preferable that Na₂O and K₂O are contained in small amounts.

Na₂O is a component capable of ion exchange reaction during chemical strengthening treatment with a potassium salt, and is a component for lowering the viscosity of glass. From the viewpoint of obtaining the above effects, the content of Na₂O is preferably 0.3% or more, more preferably in the following order: 0.5% or more; 0.8% or more; 1.0% or more; 1.2% or more; 1.5% or more; 1.8% or more; and 2.1% or more. On the other hand, the content of Na₂O is preferably 3.0% or less, more preferably 2.5% or less, from the viewpoint of maintaining glass network and avoiding a decrease of surface compressive stress (Na_CS) by strengthening treatment with a sodium salt.

K₂O is a component for not only suppressing devitrification by suppressing an increase of devitrification temperature, but also improving the ion exchange performance of glass. The content of K₂O is preferably 0.03% or more, more preferably 0.05% or more, particularly preferably 0.1% or more.

On the other hand, the content of K₂O is preferably 1.0% or less, more preferably 0.8% or less, still more preferably 0.5% or less, from the viewpoint of avoiding a decrease of surface compressive stress (K_CS) by strengthening treatment with a sodium salt.

Here, the glass may be substantially free of K₂O.

The sum of the content of Li₂O, the content of Na₂O and the content of K₂O, referred to as the total content R, is preferably 10 to 36%, more preferably 15 to 34%, still more preferably 20 to 32%, from the viewpoint of suppressing an increase of devitrification temperature and lowering the rate of crystal growth.

The ratio of the content of Li₂O to the total content R ([Li₂O]/([Li₂O]+[Na₂O]+[K₂O]); hereinafter also referred to as “Li₂O/R₂O”) is preferably 0.88 or higher, more preferably 0.89 or higher, from the viewpoint of further improvement of chemical strengthening properties in terms of deep layer stress. With a view to achieving higher chemical resistance, the Li₂O/R₂O is preferably 0.99 or lower, more preferably 0.98 or lower, particularly preferably 0.95 or lower.

The ratio of the content of Na₂O to the total content R ([Na₂O]/([Li₂O]+[Na₂O]+[K₂O]); hereinafter also referred to as “Na₂O/R₂O”) is preferably higher than 0, more preferably 0.01 or higher, still more preferably 0.02 or higher, particularly preferably 0.05 or higher, most preferably 0.06 or higher, from the viewpoint of further improvement of chemical strengthening properties in terms of deep layer stress. The Na₂O/R₂O is preferably 0.40 or lower, more preferably 0.30 or lower, still more preferably 0.20 or lower, particularly preferably 0.15 or lower, with a view to achieving higher chemical resistance.

The ratio of the content of K₂O to the total content R ([K₂O]/([Li₂O]+[Na₂O]+[K₂O]); hereinafter also referred to as “K₂O/R₂O”) is preferably 0.001 or higher, more preferably 0.004 or higher, still more preferably 0.01 or higher, from the viewpoint of increasing the electrical resistance of the glass. The K₂O/R₂O is preferably 0.50 or lower, more preferably 0.40 or lower, still more preferably 0.30 or lower, particularly preferably 0.20 or lower, from the viewpoint of further improvement of chemical strengthening properties in terms of compressive stress in the vicinity of the glass surface.

Here, the K₂O/R₂O may be zero.

The product of the Li₂O/R₂O, the Na₂O/R₂O and the K₂O/R₂O is preferably 0.00005 or higher, more preferably 0.0001 or higher, particularly preferably 0.01 or higher, from the viewpoint of suppressing an increase of devitrification temperature and lowering the rate of crystal growth. The above product is preferably 0.020 or lower.

The above product may be zero.

The ratio of the content of Na₂O to the content of Li₂O ([Na₂O]/[Li₂O]); hereinafter also referred to as “Na₂O/Li₂O”) is preferably 0.020 or higher, more preferably 0.050 or higher, still more preferably 0.10 or higher, from the viewpoint of ease of obtaining a predetermined range of maximum measured voltage after chemical strengthening. The Na₂O/Li₂O is preferably 0.200 or lower, more preferably 0.180 or lower, still more preferably 0.150 or lower.

The ratio of the content of Al₂O₃ to the total content R ([Al₂O₃]/([Li₂O]+[Na₂O]+[K₂O]); hereinafter also referred to as “Al₂O₃/R₂O”) is preferably 0.05 or higher, more preferably 0.10 or higher, still more preferably 0.15 or higher, particularly preferably 0.17 or higher. The Al₂O₃/R₂O is preferably 0.50 or lower, more preferably 0.40 or lower, still more preferably 0.30 or lower, particularly preferably 0.20 or lower.

The value given by [Al₂O₃]—[Na₂O]—[K₂O]+[Li₂O] is preferably 15.0% or more, more preferably 20.0% or more. The above value is preferably 35.0% or less, more preferably 30.0% or less.

MgO may be contained to lower the viscosity of glass during melting or the like. The content of MgO is more preferably 0.05% or more, more preferably in the following order: 0.5% or more; 1.0% or more; 2.0% or more; 3.0% or more; and 4.0% or more.

On the other hand, from the viewpoint of easily forming a larger compressive stress layer during chemical strengthening treatment, the content of MgO is more preferably 9.0% or less, still more preferably in the following order: 8.0% or less; 7.0% or less; and 6.0% or less.

Furthermore, it is possible by containing MgO to suppress transition of the crystal phase from β-quartz solid solution to β-spodumene and suppress precipitation of β-spodumene crystals. It is thus preferable that MgO is contained. From the above viewpoint, MgO is preferably contained in an amount of more than 0.5% and 7.0% or less. The further preferable ranges are as mentioned above.

The glass may be substantially free of MgO.

CaO is a component for improving the meltability of glass and thus may be contained. The content of CaO is more preferably 0.005% or more, still more preferably 0.01% or more. On the other hand, the content of CaO is more preferably 2.0% or less, still more preferably 1.0% or less, particularly preferably 0.8% or less, most preferably 0.5% or less, from the viewpoint of easily obtaining a higher compressive stress value during chemical strengthening treatment.

SrO is a component for improving the meltability of glass and thus may preferably be contained. The content of SrO is more preferably 0.1% or more, still more preferably 0.15% or more, particularly preferably 0.5% or more.

From the viewpoint of easily obtaining a higher compressive stress value during chemical strengthening treatment, the content of SrO is more preferably 3.0% or less, still more preferably 2.0% or less, particularly preferably 1.0% or less, most preferably 0.5% or less.

The glass may be substantially free of SrO.

BaO is a component for improving the meltability of glass and thus may be contained. When BaO is contained, the content of BaO is preferably 0.1% or more, more preferably 0.15% or more, still more preferably 0.5% or more.

From the viewpoint of easily obtaining a higher compressive stress value during chemical strengthening treatment, the content of BaO is preferably 3.0% or less, more preferably 2.0% or less, still more preferably 1.0% or less, particularly preferably 0.5% or less.

The glass may be substantially free of BaO.

ZnO is a component for improving the meltability of the glass. The content of ZnO is more preferably 0.1% or more, still more preferably 0.15% or more, particularly preferably 0.5% or more.

From the viewpoint of easily obtaining a higher compressive stress value during chemical strengthening treatment, the content of ZnO is more preferably 3.0% or less, still more preferably 2.0% or less, particularly preferably 1.0% or less, most preferably 0.5% or less.

The glass may be substantially free of ZnO.

InW is a parameter indicating the degree of mixing of oxides, which is calculated from the contents of alkali metal oxides, alkaline earth metal oxides and zinc oxide. Here, InW is given by the following formula (W1).

$$lnW = ln ( ( [ {Li}_{2} O ] + [ {Na}_{2} O ] + [ {K}_{2} O ] + [ MgO ] + [ CaO ] + [ SrO ] + [ BaO ] + [ ZnO ] ) ! / ( [ {Li}_{2} O ] ! \times [ {Na}_{2} O ] ! \times [ {K}_{2} O ] ! \times [ \text{} MgO ] ! \times [ \text{} CaO ] ! \times [ SrO ] ! \times [ BaO ] ! \times [ ZnO ] ! ) ) \qquad ( W1 )$$

In the formula (W1), [Li₂O], [Na₂O], [K₂O], [MgO], [CaO], [SrO], [BaO] and [ZnO] represent the contents of Li₂O, Na₂O, K₂O, MgO, CaO, SrO, BaO and ZnO, respectively, in mole percentage on the oxide basis.

Further, ! represents the factorial of a positive integer. For example, [XO]! means that the numerical value of the content of a component XO, as expressed in mole percentage on the oxide basis, is rounded to the nearest integer by discarding the decimal point, and then, the factorial of the rounded integer is calculated. Taking the Na₂O content of 4.8 mol % as an example, [Na₂O]! means to calculate the factorial of “4”, which is 4×3×2×1.

The greater the value of InW, the higher the degree of mixing of the metal oxides, whereby devitrification of the glass can be suppressed accordingly. From this viewpoint, the value of InW is preferably 10 or greater, more preferably 12 or greater, still more preferably 13 or greater, particularly preferably 14 or greater. The value of InW is preferably 20 or less, more preferably 18 or less, still more preferably 17 or less.

TiO₂, which is a component that has a high effect of suppressing solarization of glass and is a material that forms nuclei of crystals, may be contained. When TiO₂ is contained, the content of TiO₂ is preferably 0.05% or more, more preferably 0.1% or more, still more preferably 0.2% or more, particularly preferably 0.5% or more, most preferably 0.8% or more.

On the other hand, in view of the fact that TiO₂ has light absorption properties, the content of TiO₂ is preferably 2.5% or less, more preferably 2.0% or less, still more preferably 1.5% or less, particularly preferably 1.0% or less, from the viewpoint of preventing coloring of the glass.

The glass may be substantially free of TiO₂.

ZrO₂, which is a component for easily increasing surface compressive stress in chemically strengthened crystallized glass and is also a material that forms nuclei of crystals, may be contained. The content of ZrO₂ is more preferably more than 1.0%, still more preferably in the following order 2% or more, 2.5% or more, 3% or more, 3.5% or more, and 4.0% or more. The content of ZrO₂ is more preferably 8.0% or less, still more preferably 7.0% or less, particularly preferably 6.0% or less.

P₂O₅ is a component for easily forming a larger compressive stress layer during chemical strengthening. The content of P₂O₅ is more preferably 0.2% or more, still more preferably 0.5% or more.

On the other hand, the content of P₂O₅ is more preferably 3.0% or less, still more preferably 2.0% or less, with a view to achieving higher acid resistance. From the viewpoint of preventing the occurrence of striae during melting, it may also be preferable that the glass is substantially free of P₂O₅.

B₂O₃ is a component for improving the crack resistance of glass by reducing the brittleness of the glass, or for improving the meltability of glass. The content of B₂O₃ is preferably 0.5% or more, more preferably 1.0% or more, still more preferably 1.2% or more.

On the other hand, the content of B₂O₃ is preferably 8.0% or less with a view to maintaining good acid resistance. The content of B₂O₃ is more preferably 6.0% or less, still more preferably 4.0% or less, particularly preferably 2.0% or less. From the viewpoint of preventing the occurrence of striae during melting, it may also be preferable that the glass is substantially free of B₂O₃.

Y₂O₃ is a component for lowering the degree of crystal growth while easily increasing surface compressive stress in chemically strengthened crystallized glass. The content of Y₂O₃ is more preferably more than 0%, still more preferably in the following order 0.1% or more, 0.2% or more, 0.5% or more, and 0.8% or more. On the other hand, the content of Y₂O₃ is more preferably 2.0% or less, still more preferably 1.5% or less.

The glass may be substantially free of Y₂O₃.

With a view to improvement of initial solubility, the total content of ZrO₂ and Y₂O₃ is preferably 5.0% or less. The lower limit of the total content of ZrO₂ and Y₂O₃ is not particularly limited, and is preferably 0.5% or more, more preferably 1.0% or more, still more preferably 1.5% or more, with a view to achieving higher glass strength.

La₂O₃ is not an essential component, but can be contained for the same reasons as Y₂O₃. The content of La₂O₃ is preferably 0.1% or more, more preferably 0.2% or more, still more preferably 0.5% or more, particularly preferably 0.8% or more. Since too high content of La₂O₃ makes it difficult to form a larger compressive stress layer during chemical strengthening treatment, the content of La₂O₃ is preferably 5.0% or less, more preferably 3.0% or less, still more preferably 2.0% or less, particularly preferably 1.5% or less.

It may also be preferable that the glass is substantially free of La₂O₃.

Nb₂O₅, Ta₂O₅, Gd₂O₃ and CeO₂ are components that have the effect of suppressing solarization of glass and improving the meltability of glass, and thus may be contained. The content of each of Nb₂O₅, Ta₂O₅, Gd₂O₃ and CeO₂, when contained, is preferably 0.03% or more, more preferably 0.1% or more, still more preferably 0.5% or more, particularly preferably 0.8% or more, most preferably 1.0% or more. On the other hand, the content of each of Nb₂O₅, Ta₂O₅, Gd₂O₃ and CeO₂ is preferably 3.0% or less, more preferably 2.0% or less, still more preferably 1.0% or less.

Fe₂O₃ is capable of absorbing heat ray and thus is effective in improving glass meltability. In the case of mass-production of the glass by the use of a large melting furnace, it is preferable that Fe₂O₃ is contained. In such a case, the content of Fe₂O₃ in mass % on the oxide basis is preferably 0.002% or more, more preferably 0.005% or more, still more preferably 0.007% or more, particularly preferably 0.01% or more. On the other hand, too high content of Fe₂O₃ leads to coloring of the glass. From the viewpoint of enhancing the transparency of the glass, the content of Fe₂O₃ in mass % on the oxide basis is preferably 0.3% or less, more preferably 0.04% or less, still more preferably 0.025% or less, particularly preferably 0.015% or less.

An additional coloring component may be contained within the range that does not inhibit the achievement of the desired chemical strengthening properties. Suitable examples of the additional coloring component include Co₃O₄, MnO₂, NiO, CuO, Cr₂O₃, V₂O₅, Bi₂O₃, SeO₂, Er₂O₃, Nd₂O₃, and the like.

As a fining agent in melting of the glass, SO₃, a chloride, a fluoride or the like may be contained as appropriate. It is preferred that As₂O₃ is not contained. When Sb₂O₃ is contained, the content of Sb₂O₃ is preferably 0.3% or less, more preferably 0.1% or less. Most preferably, Sb₂O₃ is not contained.

From the viewpoint of (re)fining of bubbles in the glass, the content of SnO₂ is preferably 0.05% or more, more preferably 0.07% or more. From the viewpoint of suppressing the occurrence of defects, the content of SnO₂ is preferably 1% or less, more preferably 0.8% or less, still more preferably 0.7% or less, particularly preferably 0.5% or less.

It is preferable that the glass for chemical strengthening is in the form of crystallized glass.

The crystallized glass preferably contains, for example, at least one type selected from the group consisting of lithium silicate crystal, lithium aluminosilicate crystal and lithium phosphate crystal, more preferably at least one type selected from the group consisting of lithium silicate crystal and lithium aluminosilicate crystal.

Preferable examples of the lithium silicate crystal include lithium metasilicate (Li₂SiO₃) crystal and lithium disilicate (Li₂Si₂O₅) crystal. Preferable examples of the lithium phosphate crystal include lithium orthophosphate (Li₃PO₄) crystal. Preferable examples of the lithium aluminosilicate crystal include β-spodumene (LiAlSi₂O₆) crystal, β-quartz solid solution (LiAlSiO₄) crystal and petalite (LiAlSi₄O₁₀) crystal.

It is also preferable that the crystalline glass contains at least one type selected from the group consisting of lithium disilicate crystal, β-spodumene crystal, β-quartz solid solution crystal and petalite crystal.

In the case where the glass for chemical strengthening is in the form of crystallized glass, the crystallinity of the glass is preferably 10% or higher, more preferably 15% or higher, still more preferably 20% or higher, particularly preferably 25% or higher, with a view to achieving higher mechanical strength. Further, the crystallinity of the glass is preferably 70% or lower, more preferably 60% or lower, still more preferably 50% or lower, with a view to achieving higher transparency. The crystallized glass, when low in crystallinity, is also excellent in ease of bending by heating. The crystallinity can be determined from an X-ray diffraction pattern by the Rietveld method. The Rietveld method is as described in “Crystal Analysis Handbook” edited by the Crystallographic Society of Japan “Crystal Analysis Handbook” Editing Committee (Kyoritsu Shuppan, 1999, p. 492-499).

In the case where the glass for chemical strengthening is in the form of crystallized glass, the average particle size of precipitated crystals in the glass is preferably 300 nm or smaller, more preferably 200 nm or smaller, still more preferably 150 nm or smaller, particularly preferably 100 nm or smaller, with a view to achieving higher transparency. The average particle size of precipitated crystals can be determined from a transmission electron microscope (TEM) image, and can also be estimated from a scanning electron microscope (SEM) image.

### (Physical Properties)

The preferable physical properties of the glass for chemical strengthening will be next described below.

The glass for chemical strengthening preferably has a devitrification temperature of 1300° C. or lower. The devitrification temperature is more preferably 1280° C. or lower, still more preferably 1250° C. or lower, particularly preferably in the following order 1240° C. or lower, 1230° C. or lower, 1220° C. or lower, and 1210° C. or lower. The lower limit of the devitrification temperature is not particularly limited, and is usually 1100° C. or higher.

The crystallization start temperature Tcs of the glass for chemical strengthening (the glass with the above base glass composition) is preferably 500° C. or higher as measured by differential scanning calorimetry (DSC). The upper limit of the crystallization start temperature Tcs is not particularly limited, and is usually 800° C. or lower.

When the crystallization start temperature Tcs is in the above range, the glass for chemical strengthening is obtained as crystallized glass by causing precipitation of crystals in the glass through heat treatment of holding the glass at 500 to 600° C. for 1 to 6 hours and holding the glass at 600 to 800° C. for 0.5 to 6 hours.

The heat treatment may be performed in three steps. For example, the glass for chemical strengthening can be obtained as crystallized glass by holding the glass at 500 to 600° C. for 1 to 6 hours, holding the glass at 550 to 650° C. for 0.5 to 6 hours and then holding the glass at 600 to 800° C. for 0.5 to 6 hours.

The glass transition temperature Tg of the glass for chemically strengthening is preferably 500° C. or higher, more preferably 520° C. or higher, still more preferably 540° C. or higher, from the viewpoint of reducing warpage of the glass after chemical strengthening. From the viewpoint of ease of float forming, the glass transition temperature Tg of the glass for chemical strengthening is preferably 750° C. or lower, more preferably 700° C. or lower, still more preferably 650° C. or lower, particularly preferably 600° C. or lower, most preferably 580° C. or lower.

The crystallization peak temperature Tc of the glass for chemical strengthening (the glass with the above base glass composition) is preferably 600° C. or higher, more preferably 650° C. or higher, still more preferably 700° C. or higher. When the crystallization peak temperature Tc is 600° C. or higher, stable forming of the glass can be achieved. It is most preferable that no crystallization peak is observed. The upper limit of the crystallization peak temperature Tc is not particularly limited, and is usually 950° C. or lower.

The β-OH value of the glass for chemically strengthening preferably 0.1 mm⁻¹ or higher, more preferably 0.15 mm⁻¹ or higher, still more preferably 0.2 mm⁻¹ or higher, particularly preferably 0.22 mm⁻¹ or higher, most preferably 0.25 mm⁻¹ or higher.

The β-OH value is an index for the content of water in glass. Glass with a higher β-OH value has a lower softening point and tends to be easier to bend. On the other hand, from the viewpoint of strength improvement of glass by chemical strengthening, the surface compressive stress (CS) of glass after chemical strengthening tends to be lower as the glass has a higher β-OH value. From the above viewpoints, the β-OH value is preferably 0.5 mm⁻¹ or lower, more preferably 0.4 mm⁻¹ or lower, still more preferably 0.3 mm⁻¹ or lower.

The fracture toughness value (K_{IC}) of the glass for chemical strengthening is preferably 0.80 MPa·m^{1/2} or higher, more preferably 0.85 MPa·m^{1/2} or higher, still more preferably 0.90 MPa·m^{1/2} or higher, particularly preferably 1.00 MPa·m^{1/2} or higher, most preferably 1.10 MPa·m^{1/2} or higher. The upper limit of the fracture toughness value K_{IC} is not particularly limited, and is typically 1.60 MPa·m^{1/2} or lower.

The Young's modulus of the glass for chemical strengthening is preferably 80 GPa or higher, more preferably 85 GPa or higher, still more preferably 90 GPa or higher, particularly preferably 95 GPa or higher, most preferably 100 GPa or higher. The upper limit of the Young's modulus is not particularly limited, and is typically 120 GPa or lower.

The method for measuring the Young's modulus of the glass for chemical strengthening is as described later in Examples.

### [Chemical Strengthening Treatment]

In the method for producing the chemically strengthened glass of the present invention, chemical strength treatment is performed on the glass for chemical strengthening by contact with a molten salt.

When the glass for chemical strengthening is brought into contact with the molten salt, metal ions of small ionic radius (typically, Na ions or Li ions) inside the glass for chemical strengthening are exchanged with metal ions of larger ionic radius (typically, K ions for Na ions, Na ions or K ions for Li ions).

The method for bringing the glass for chemical strengthening into contact with the molten salt is not particularly limited. For example, the glass for chemical strengthening may be immersed in the molten salt.

In the following, the chemical strengthening treatment will be described.

### (Molten Salt)

The molten salt used for production of the chemically strengthened glass of the present invention will be first described below.

The content of KNO₃ in the molten salt is 60 mass % or more, preferably 65 mass % or more, to the total mass of the molten salt. Further, the content of KNO₃ in the molten salt is 80 mass % or less, preferably 75 mass % or less, to the total mass of the molten salt.

The content of NaNO₃ in the molten salt is 20 mass % or more, preferably 25 mass % or more, to the total mass of the molten salt. Further, the content of NaNO₃ in the molten salt is 40 mass % or less, preferably 35 mass % or less, to the total mass of the molten salt.

By performing the chemical strengthening treatment with the molten salt of the above composition, the chemically strengthened glass having the above predetermined range of maximum measured voltage is easily obtained.

The molten salt may contain a component other than KNO₃ and NaNO₃.

The component other than KNO₃ and NaNO₃ can be, for example, at least one type of metal salt selected from the group consisting of a nitrate, a sulfate, a carbonate, a chloride and the like.

Examples of the nitrate include lithium nitrate (LiNO₃), rubidium nitrate (RbNO₃), cesium nitrate (CsNO₃) and silver nitrate (AgNO₃). Examples of the sulfate include lithium sulfate (Li₂SO₄), sodium sulfate (Na₂SO₄), potassium sulfate (K₂SO₄), rubidium sulfate (Rb₂SO₄), cesium sulfate (Cs₂SO₄) and silver sulfate (Ag₂SO₄). Examples of the carbonate include lithium carbonate (Li₂CO₃), sodium carbonate (Na₂CO₃) and potassium carbonate (K₂CO). Examples of the chloride include lithium chloride (LiCl), sodium chloride (NaCl), potassium chloride (KCl), rubidium chloride (RbCl), cesium chloride (CsCl) and silver chloride (AgCl).

The molten salt may preferably contain any component other than the above-described components.

The component other than the above-described components can be at least one type of metal salt selected from the group consisting of a phosphate and a silicate.

Examples of the phosphate include lithium phosphate, sodium phosphate, potassium phosphate and rubidium phosphate.

Examples of the silicate include lithium silicate, sodium silicate, potassium silicate and rubidium silicate.

### (Treatment Conditions)

In the method for producing the chemically strengthened glass of the present invention, the treatment temperature of the chemical strengthening treatment is 450° C. or higher. Here, the expression “the treatment temperature of the chemical strengthening treatment is 450° C. or higher” means that the temperature of the molten salt brought into contact with the glass for chemical strengthening is 450° C. or higher. In the following, the treatment temperature of the chemical strengthening treatment also means the temperature of the molten salt brought into contact with the glass for chemical strengthening.

The treatment temperature of the chemical strengthening treatment is preferably 480° C. or lower. In other words, the treatment temperature of the chemical strengthening treatment is preferably from 450 to 480° C.

In the method for producing the chemically strengthened glass of the present invention, the treatment time of the chemical strengthening treatment is 6 hours or more. Here, the treatment time of the chemical strengthening treatment means the time of contact of the glass for chemical strengthening with the molten salt.

The treatment time of the chemical strengthening treatment is preferably 7 hours or more, and may be 10 hours or more, or may be 12 hours or more. The treatment time of the chemical strengthening treatment is preferably 48 hours or less, more preferably 36 hours or less.

By performing the chemical strengthening treatment with the molten salt of the above composition at the above temperature for the above time, the chemically strengthened glass having the above predetermined range of maximum measured voltage is easily obtained.

### <Uses>

The chemically strengthened glass of the present invention is useful, for example, as cover glasses.

The cover glasses are suitably applicable for the purposes of surface protection of displays, solar cell modules, and the like. In the case where the chemically strengthened glass of the present invention is applied as a cover glass, the cover glass has a surface less likely to be charged, less prone to adhesion of dust etc. and excellent in appearance.

The chemically strengthened crystallized glass of the present invention is particularly useful as cover glasses for mobile devices such as mobile phones, smartphones, personal digital assistants (PDA), tablet terminals and the like. The chemically strengthened crystallized glass of the present invention is also useful for applications not intended for mobile uses, as typified by: cover glasses for display devices of televisions (TVs), personal computers (PCs), touch panels and the like; cover glasses on surfaces of solar cell modules; walls of elevators; walls (full-screen displays) of houses and buildings; architectural materials such as window glass; table tops; and interior parts of automobiles, aircrafts and the like. The chemically strengthened glass of the present invention is further useful as cover glasses for the above articles. Furthermore, the chemically strengthened glass of the present invention can be applied to casings with curved shapes and other applications by bending or bend-forming.

The chemically strengthened glass of the present invention is also applicable to display modules, touch panel modules and the like. Since the chemically strengthened glass has a surface less likely to be charged, the modules to which the chemical strengthened glass of the present invention is applied are excellent in electrostatic discharge resistance.

For example, when the chemically strengthened glass of the present invention is applied to the above modules, malfunctions of the modules can be reduced. More specifically, the display module attains reduction of abnormal light emission due to charges; and the touch panel module attains reduction of reading errors due to charges.

### Examples

Now, the present invention will be described in further detail with reference to the following Examples.

The materials, amounts used, proportions, treatment operations, treatment procedures etc. shown in the following Examples can be modified as appropriate without departing from the gist of the present invention. It should thus be understood that the scope of the present invention is by no means restricted to the following Examples.

In the following, Ex. 1 to 6 correspond to Comparative Examples; and Ex. 7 and 8 correspond to Examples of the present invention.

### <Preparation of Glass for Chemical Strengthening>

Glass materials A and B were each prepared by melting glass raw materials in a platinum crucible to have a glass composition in mole percentage on the oxide basis as shown in FIG. 1.

More specifically, oxides, hydroxides, carbonates and nitrates used as the glass raw materials were selected from commonly used glass raw materials as appropriate and weighed and mixed in amounts corresponding to 1000 g of glass.

The resulting raw material mixture was put in a platinum crucible, melted in a resistance-heating electric furnace at 1500 to 1700° C. for about 3 hours and subjected to degassing and homogenization to obtain a molten glass. The obtained molten glass was formed into glass blocks by pouring and holding the molten glass in a mold for 1 hour at a temperature higher by 50° C. than the glass transition temperature and cooling the molded glass to room temperature at a rate of 0.5° C./min. The glass block was processed into sheet glass by cutting and grinding.

Here, the glass material A was, after processed into sheet glass, heat-treated by heating to and holding at 550° C. for 2 hours and heating to and holding at 750° C. for 2 hours.

The glass material B was, after processed into sheet glass, heat-treated by heating to and holding at 540° C. for 4 hours, heating to and holding at 600° C. for 4 hours and then heating to and holding at 650° C. for 4 hours.

By the above heat treatment, crystallized glass with crystals precipitated therein was obtained. The thus-obtained crystallized glass was used as glass for chemical strengthening.

The crystal species and crystallinity of the glass after the heat treatment are shown in Table 1 below.

Further, the same heat treatment as above was separately performed on the glass block. Sample pieces for measurements of fracture toughness value (K_{IC}) and Young's modulus were obtained from the heat-treated glass block. The fracture toughness value and Young's modulus of the obtained sample pieces were measured by the methods described later.

TABLE 1

| | | |
|---|---|---|
| Glass material | A | B |

| | | | |
|---|---|---|---|
| Composition | SiO₂ | 61 | 68.4 |
| (mol %) | B₂O₃ | 0 | 1.4 |
| | Al₂O₃ | 5 | 4.4 |
| | P₂O₅ | 2 | 0.7 |
| | Y₂O₃ | 1 | 0 |
| | Li₂O | 21 | 21 |
| | Na₂O | 2 | 2.4 |
| | K₂O | 0 | 0 |
| | MgO | 5 | 0 |
| | CaO | 0 | 0.01 |
| | SrO | 0 | 0 |
| | ZnO | 0 | 0 |
| | ZrO₂ | 3 | 1.6 |
| | TiO₂ | 0 | 0 |
| | SnO₂ | 0 | 0.1 |
| | Fe₂O₃ | 0 | 0 |
| | SUM | 100.0 | 100.0 |

| | | |
|---|---|---|
| Main crystal species | Li₃PO₄ | LiAlSi₄O₁₀ |
| Crystallinity (%) | 30 | 50 |
| R = Li₂O + Na₂O + K₂O | 23 | 23.4 |
| a =Li₂O/R | 0.913 | 0.897 |
| b = Na₂O/R | 0.087 | 0.103 |
| c = K₂O/R | 0.00 | 0.000 |
| Q = Al₂O₃/R | 0.22 | 0.19 |
| S = a × b × c | 0.000 | 0.00000 |
| Na₂O/Li₂O | 0.095 | 0.114 |
| K_{IC}(MPa · m^{1/2}) | 0.88 | 1.2 |
| Young's modulus (GPa) | 95 | 108 |

### <Production of Chemically Strengthened Glass>

The above-obtained glasses for chemical strengthening (glass materials A and B) were chemically strengthened under the conditions shown in Table 2, thereby obtaining glasses (chemically strengthened glasses) of Ex. 2 to 4 and 6 to 8.

In Ex. 1 and 5, the above-obtained glasses for chemical strengthening (glass materials A and B) were used as they were without chemical strengthening treatment.

### <Measurement of Charge Characteristics>

The charge characteristics of the glass of each Ex. were measured by the methods described above.

More specifically, the maximum voltage (V_{MAX}) of the glass was measured by the above-described charge test, and the voltage (V_{2S}) of the glass was measured at a lapse of 2 seconds from the stop of the corona discharge after the charge test.

From the measured values V_{MAX} and V_{2S}, the ratio V_{2S}/V_{MAX} was calculated.

### <Measurement of Stress Profile>

A stress profile of the chemically strengthened glass was measured by the method described above, and the respective parameters shown in Table below were determined from the stress profile.

### <Analysis of Elemental Distribution>

The elemental distribution of the glass of each Ex. was analyzed by the method described above to determine the distribution of K in the depth direction.

More specifically, the analysis was carried out under the following conditions with the use of a glow discharge optical emission spectrometer (GD-OES; GD-Profiler 2 manufactured by Horiba, Ltd.).
Measurement pressure: 200 Pa
Discharge condition: 40 W (low-power mode)
Discharge area: 4 mm in diameter
Measurement method: discharge-mode pulsed sputtering method (duty cycle: 0.25 DS)

From the obtained depth-direction distribution data of the respective elements, the depth-direction distribution of K was extracted. For example, in the depth-direction distribution of K in the glass of Ex. 7, the detection amount of K increased from the sheet thickness center position to the surface (depth of 0 μm).

A difference K_{MAX} between the detection amount (Kc) of K at the sheet thickness center position and the detection amount of K at the surface (depth of 0 μm) was determined from the depth-direction distribution of K. Here, the depth at which the detection amount of K became larger by a value of multiplication of K_{MAX} by 0.1 than Kc was determined and taken as the K ion exchange depth.

### <Measurement of Young's Modulus>

Using the sample piece cut out in the process of obtaining the glass material, the Young's modulus of the glass for chemical strengthening was measured by the ultrasonic pulse method according to JIS R1602.

The Young's modulus of the glass after the chemical strengthening treatment was measured by the same method and found to be the same as that before the chemical strengthening treatment.

### <Measurement of Fracture Toughness Value>

Using the sample piece cut out in the process of obtaining the glass material, the fracture toughness value K_{IC} of the glass for chemical strengthening was measured by the above-described DCDC method.

The fracture toughness value K_{IC} of the glass after the chemical strengthening treatment was measured by the same method and found to be the same as that before the chemical strengthening treatment.

### <Evaluation of Drop Strength>

The drop strength of the glass of each Ex. was evaluated by the following procedure.

The glass of each Ex. was attached to a structural member whose mass and rigidity were adjusted to those of commonly used smartphones, thereby providing a dummy smartphone. The dummy smartphone was dropped freely, with the glass side thereof facing the ground, onto #80 SiC sandpaper from varying heights. The height of drop was first set to 20 cm. In the case where the glass was not broken even when dropped from the height of 20 cm, the height of drop was changed to 25 cm. In the case where the glass was not broken even when dropped from the height of 25 cm, the height of drop was changed to 30 cm. The above drop test was repeatedly performed, until breakage of the glass occurred, by incrementing the height of drop by 5 cm as mentioned above. The height of drop at which breakage of the glass first occurred was taken as a drop height.

The above drop height measurement was performed on 19 sheets of the glass. An arithmetic means of the drop height measurement results was indicated as the drop height in Table below.

A greater drop height means that glass was not broken even when dropped from a higher position, that is, glass was higher in drop strength.

### <Evaluation of Four-Point Bending Strength>

The four-point bending strength of the glass of each Ex. was evaluated by the following four-point bending test (4PB bending test).

The 4PB bending test was conducted according to JIS R1601:2008 with the use of a tabletop-type precision universal tester “Autograph AGS-10kNX” manufactured by Shimadzu Corporation. In the bending test, the upper span was set to 20 mm; the lower span was set to 40 mm; and the crosshead speed was set to 5 mm/min. A load with which breakage of the glass occurred was measured to determine a breakage stress.

The above breakage stress measurement was performed on five samples of the glass. An arithmetic mean of the breakage stress measurement results was taken as an average breakage stress.

The type of the glass for chemical strengthening used, the chemical strengthening treatment conditions and the measurement and evaluation results of each Ex. are shown in Table 2.

The parameters shown in the stress profile column of Table 2 have the following meanings. The determination methods for these parameters were as described above or as described later.
CS₅₀ and CS₁₀₀: Compressive stress at respective depths (unit: μm) in chemically strengthened glass
DOC: Depth of compressive stress layer of chemically strengthened glass

Here, the parameter “DOC” refers a depth at which the value of compressive stress in a stress distribution as measured by means of only a scattered light photoelastic stress meter became 0 MPa.
DOC/t: Value obtained by dividing DOC (unit: μm) by sheet thickness t (unit: μm)

Here, both of the DOC and the sheet thickness t are indicated in μm.
CT_{Max}: Maximum value of tensile stress
CTₐᵥₑ: Average value of tensile stress
ICT: Integral value of tensile stress
K ion exchange depth: Depth of introduction of K by ion exchange
V_{MAX}: Maximum measured voltage
V_{2S}: Voltage measured at lapse of 2 seconds from stop of corona discharge after charge test

TABLE 2

| | | | Ex. 1 | Ex. 2 | Ex. 3 | Ex. 4 | Ex. 5 | Ex. 6 | Ex. 7 | Ex. 8 |
|---|---|---|---|---|---|---|---|---|---|---|
| Glass material | | | A | A | A | A | B | B | B | B |
| Sheet thickness | | (mm) | 0.6 | 0.6 | 0.6 | 0.6 | 0.6 | 0.6 | 0.6 | 0.6 |
| Chemical | Molten salt composition | KNO₃ | — | 70 | 70 | 70 | — | 70 | 70 | 70 |
| strengthening | (mass %) | NaNO₃ | — | 30 | 30 | 30 | — | 30 | 30 | 30 |
| treatment | Temperature | (° C.) | — | 450 | 450 | 450 | — | 450 | 450 | 450 |
| | Time | (min) | — | 180 | 420 | 900 | — | 180 | 420 | 900 |
| Characteristics | DOC | (μm) | — | 127 | 144 | 145 | — | 105 | 110 | 110 |
| | DOC/t | (—) | — | 0.21 | 0.24 | 0.24 | — | 0.18 | 0.18 | 0.18 |
| | CS₅₀ | (MPa) | — | 277 | 245 | 167 | — | 40 | 47 | 55 |
| | CS₁₀₀ | (MPa) | — | 85 | 108 | 77 | — | 3 | 5 | 10 |
| | CTMax | (MPa) | — | 178 | 211 | 148 | — | 48 | 54 | 56 |
| | CTave | (MPa) | — | 130 | 134 | 94 | — | 34 | 38 | 38 |
| | ICT | (Pa · m) | — | 45000 | 41830 | 28940 | — | 13200 | 14000 | 15000 |
| | K ion exchange depth | (μm) | 0.0 | 4.5 | 7.0 | 10.0 | 0.0 | 1.0 | 2.0 | 3.5 |
| | V_{MAX} | (V) | 1330 | 1541 | 1700 | 1240 | 2096 | 1508 | 667 | 26 |
| | V_{2S} | (V) | 513 | 953 | 1093 | 365 | 1904 | 467 | 38 | 0.050 |
| | V_{2S}/V_{MAX} | — | 0.386 | 0.618 | 0.643 | 0.294 | 0.908 | 0.310 | 0.057 | 0.002 |
| | Drop height | (cm) | 40 | 70 | 75 | 66 | 72 | 75 | 80 | 85 |
| | 4PB bending strength | (MPa) | 300 | 900 | 800 | 850 | 250 | 750 | 720 | 700 |

As is apparent from the results shown in Table 2, each of the glasses of Ex. 7 and 8 corresponding to the chemically strengthened glass of the present invention was confirmed to be a novel type of glass having a maximum measured voltage (V_{MAX}) with an absolute value of 800 V or smaller as measured by the above-described method.

Further, each of the glasses of Ex. 7 and 8 corresponding to the chemically strengthened glass of the present invention was excellent in drop strength as compared to the glasses of the other Ex.

The entire disclosure of Japanese Patent Application No. 2024-161665 filed on Sep. 19, 2024, including specification, claims, drawings and summary, is incorporated herein by reference in its entirety.

What is claimed is:

1. Chemically strengthened glass having a maximum measured voltage with an absolute value of 800 V or less as measured by a static honestmeter in a charge test in which the chemically strengthened glass is charged for 30 seconds by generating a corona discharge at an applied voltage of 10 kV.

2. The chemically strengthened glass according to claim 1, wherein the ratio of a voltage of the chemically strengthened glass as measured at a lapse of 2 seconds from the stop of the corona discharge after the charge test, to the maximum measured voltage, is 0.200 or lower.

3. The chemically strengthened glass according to claim 1, wherein a Young's modulus of the chemically strengthened glass is 90 GPa or higher.

4. The chemically strengthened glass according to claim 1, wherein a depth in μm of compressive stress layer DOC of the chemically strengthened glass is greater than or equal to 0.16 times a sheet thickness in μm of the chemically strengthened glass.

5. The chemically strengthened glass according to claim 1, wherein an average value CTₐᵥₑ of tensile stress in the chemically strengthened glass is 80 MPa or lower.

6. The chemically strengthened glass according to claim 1, wherein a potassium ion exchange depth of the chemically strengthened glass is 1.8 μm or greater.

7. The chemically strengthened glass according to claim 1, wherein a sheet thickness of the chemically strengthened glass is 1.0 mm or smaller.

8. The chemically strengthened glass according to claim 1, wherein the chemically strengthened glass is in the form of crystallized glass.

9. The chemically strengthened glass according to claim 8, wherein the crystallized glass comprises at least one type selected from the group consisting of lithium silicate crystal and lithium aluminosilicate crystal.

10. The chemically strengthened glass according to claim 8, wherein the crystallized glass comprises at least one type selected from the group consisting of lithium disilicate crystal, β-spodumene crystal, β-quartz solid solution crystal and petalite crystal.

11. A method for producing chemically strengthened glass, comprising performing chemical strengthening treatment on glass for chemical strengthening by contact with a molten salt to obtain chemically strengthened treatment,
wherein the content of KNO₃ in the molten salt is 60 mass % or more to the total mass of the molten salt, and the content of NaNO₃ in the molten salt is 20 mass % or more to the total mass of the molten salt, and
wherein a treatment temperature of the chemical strengthening treatment is 450° C. or higher, and a treatment time of the chemical strengthening treatment is 6 hours or more.

12. The method for producing chemically strengthened glass according to claim 11, wherein the treatment temperature of the chemical strengthening treatment is from 450 to 480° C.

13. The method for producing chemically strengthened glass according to claim 11, wherein the treatment time of the chemical strengthening treatment is from 6 to 24 hours.

14. The method for producing chemically strengthened glass according to claim 11, wherein the glass for chemical strengthening is in the form of crystallized glass.

15. The method for producing chemically strengthened glass according to claim 14, wherein the crystallized glass comprises at least one type selected from the group consisting of lithium silicate crystal and lithium aluminosilicate crystal.

16. The method for producing chemically strengthened glass according to claim 14, wherein the crystallized glass comprises at least one type selected from the group consisting of lithium disilicate crystal, β-spodumene crystal, β-quartz solid solution crystal and petalite crystal.
